(19) United States
(12) Patent Application Publication
(10) Pub. No.: US 2005/0264838 A1
(43) Pub. Date: Dec. 1, 2005

(54) Method and system to print data over network

(76) Inventor: Hyun-Chul Kim, Suwon-si (KR)

Correspondence Address: STANZIONE & KIM, LLP, 919 18TH STREET, N.W., SUITE 440, WASHINGTON, DC, 20006, US

(21) Appl. No.: 11/111,876

(22) Filed: Apr. 22, 2005

(30) Foreign Application Priority Data
May 31, 2004 (KR) 2004-39240

(51) Int. Cl. G06F 15/00

(52) U.S. Cl. 358/1.13; 358/1.15

(57) ABSTRACT

A method and system to print data over a network include analyzing header information of print data input to the printing device and determining an interpreter corresponding to the print data, requesting from the server in which a plurality of interpreters are stored the determined interpreter, withdrawing the requested interpreter from the server and transmitting the withdrawn interpreter to the printing device, and printing the print data using the received interpreter. Accordingly, the print data can be printed without storing various kinds of interpreters in the printing device, and thus, a memory space needed for the interpreters in the printing device is reduced.

### CROSS-REFERENCE TO RELATED APPLICATIONS

This application claims the priority under 35 U.S.C. § 119 of Korean Patent Application No. 2004-39240, filed on May 31, 2004, in the Korean Intellectual Property Office, the disclosure of which is incorporated herein in its entirety by reference.

### BACKGROUND OF THE INVENTION

1. Field of the Invention

The present general inventive concept relates to printing performed by a printing device, such as a printer and a multi-functional machine, and more particularly, to a method and system to print data over a network using a server and a printing device that is connected to the server via the network.

2. Description of the Related Art

Printing devices include a plurality of interpreters, the interpreters being packaged with a kernel, an operating system (OS), etc. Also, the printing devices include an auto-parser for determining which of the plurality of interpreters to use. When a user sends print data to a printing device, the auto-parser of the printing device determines which interpreter is used to print the received print data. The interpreter selected by the auto-parser among the plurality of interpreters stored in the printing device is withdrawn and used to print the data.

A conventional printing device needs an interpreter to be available to print data, and thus always has various kinds of interpreters stored therein to print various data. Consequently, if a new interpreter other than those embedded in the conventional printing device is required to print certain data, the conventional printing device encounters a problem in printing the certain data.

In addition, since the conventional printing device has the plurality of interpreters stored therein to print the various data, the plurality of interpreters require a large memory space to be stored therein.

### SUMMARY OF THE INVENTION

The present general inventive concept provides a method of printing data over a network without storing various kinds of interpreters in a printing device.

The present general inventive concept also provides a system to print data over a network without storing various kinds of interpreters in a printing device.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of printing data over a network using a server and a printing device that is connected to the server via the network, the method including analyzing header information of print data input to the printing device and determining an interpreter corresponding to the print data, requesting from the server in which a plurality of interpreters are stored the determined interpreter, withdrawing the requested interpreter from the server and transmitting the withdrawn interpreter to the printing device, and printing the print data using the transmitted interpreter.

The forgoing and/or other aspects and advantages of the present general inventive concept are also achieved by providing a method of printing print data, the method including determining an interpreter corresponding to input print data, downloading the determined interpreter from a server via a network, storing the downloaded interpreter in a memory, and printing the print data using the stored interpreter.

The foregoing and/or other aspects and advantages of the present general inventive concept are also achieved by providing a system to print data over a network, the system including a server and a printing device connected to the server via the network, wherein the printing device includes an interpreter determining unit which analyzes header information of print data and determines an interpreter corresponding to the print data, an interpreter requesting unit which requests from the server the determined interpreter, an interpreter storing and removing unit, which stores the interpreter transmitted from the server, and a data printing unit, which prints the print data using the stored interpreter, and the server includes an interpreter database in which a plurality of interpreters are stored, and an interpreter withdrawing unit, which withdraws the requested interpreter from the interpreter database and transmits the withdrawn interpreter to the printing device.

The foregoing an/or other aspects and advantages of the present general inventive concept are also achieved by providing a system to print data, the system including a server to store a plurality of interpreters therein, and a printing device including an interpreter determining unit to determine an interpreter corresponding to input print data, an interpreter requesting unit to download the determined interpreter from the server, a storage to store the downloaded interpreter, and a printing unit to print the print data using the interpreter stored in the storage, and a network to provide a communication link between the printing device and the server.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a system to print data over a network illustrating a network printing method and system according to an embodiment of the present general inventive concept;

FIG. 2 is a flow chart of a method of printing data over a network according to an embodiment of the present general inventive concept; and

FIG. 3 is a block diagram of a system to print data over a network according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

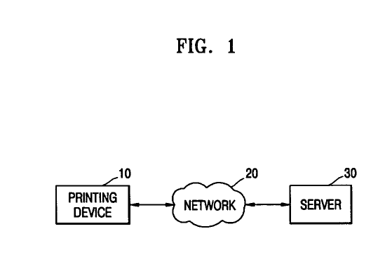

FIG. 1 is a block diagram of a system to print data over a network to illustrate a network printing method and system according to the present general inventive concept. Referring to FIG. 1, a network printing system includes a printing device 10, and a server 30 to which the printing device 10 is connected via a network 20.

The printing device 10 may be a printer, a multi-functional machine with printing capabilities, or the like.

The network 20 can be a wired or wireless communication network that connects the printing device 10 to the server 30, and may be the Internet or a local area network (LAN).

The server 30 can be a database server in which a plurality of interpreters are stored.

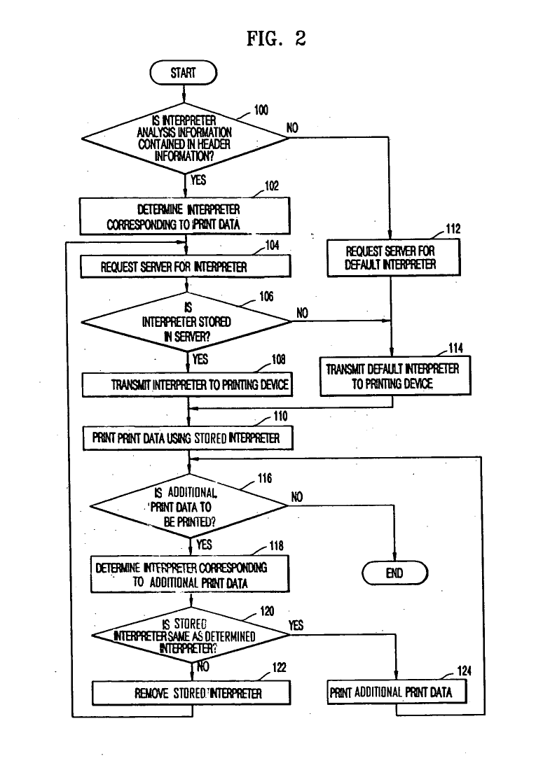

FIG. 2 is a flow chart of a method of printing data over the network 20 according to an embodiment of the present general inventive concept. The method includes operations 100 through 124 in which a request is made to the server 30 for an interpreter corresponding to print data and the print data is printed using the corresponding interpreter.

First, at operation 100, it is checked whether interpreter analysis information is contained in header information of the print data input to the printing device 10. If the print data is input to the printing device 10 from a computer or the like, the header information of the print data, which is present in a header part of the print data, is also transmitted to the printing device 10. The interpreter analysis information indicates which interpreter corresponds to the print data.

If it is determined at operation 100 that the interpreter analysis information is contained in the header information of the print data, then the header information of the print data is analyzed and the interpreter corresponding to the print data is determined at operation 102. The fact that the interpreter analysis information is contained in the header information means that information about which interpreter is required to print the print data is contained in the header information. If the interpreter analysis information is contained in the header information, the header information is analyzed and the interpreter corresponding to the print data is determined to be the interpreter necessary to print the first print data according to the interpreter analysis information.

Next, at operation 104, a request is made to the server 30, in which the plurality of interpreters are stored, for the determined interpreter corresponding to the print data. As described above, the server 30 has the plurality of interpreters stored therein. The plurality of interpreters are required to print various print data. The request made to the server 30 for the interpreter determined at operation 102, as described above, is made via the network 20.

Next, at operation 106, it is determined whether the requested interpreter corresponding to the print data is stored in the server 30. This determination can be made by the server 30 itself. For example, when request is made to the server 30 for the interpreter, the server 30 checks whether the requested interpreter exists among the plurality of interpreters stored therein.

If the requested interpreter is determined to be stored in the server 30, the process goes to operation 108. At operation 108, the requested interpreter is transmitted to the printing device 10 from the server 30. More specifically, when the requested interpreter is stored in the server 30, the requested interpreter is transmitted to the printing device 10 from the server 30 via the network 20. The transmitted interpreter is then stored in a predetermined memory of the printing device 10 after being received from the server 30.

Next, at operation 110, the printing device 10 prints the print data using the received and stored interpreter corresponding to the print data. The print data input to the printing device 10 is interpreted by the stored interpreter, and is printed by a print engine (not shown) of the printing device 10.

If it is determined at operation 100 that the interpreter analysis information is not contained in the header information of the print data, the process goes to operation 112. At operation 112, a request is made to the server 30 for a preset default interpreter. The server 30 can preset the default interpreter in advance. An interpreter that is most often used for various print data can be preset as the default interpreter.

Next, at operation 114, the preset default interpreter is transmitted to the printing device 10 from the server 30 via the network 20. The transmitted default interpreter is stored in the predetermined memory of the printing device 10. Thereafter, the process goes to operation 110. In this case, at operation 110, the print data is printed using the stored default interpreter. Since the print data is printed using the preset default interpreter, which may not be suitable for the print data, a printed image of the print data may not have a desired output quality.

In the meantime, if it is determined at operation 106 that the requested interpreter is not stored in the server 30, the process goes to operation 114. At operation 114, the default interpreter is transmitted to the printing device 10 from the server 30. If the interpreter corresponding to the print data requested by the printing device 10 is not stored in the server 30, the preset default interpreter is transmitted to the printing device 10 from the server 30 at operation 114 via the network 20, and the print data is printed using the preset default interpreter at operation 110.

Next, at operation 116, it is determined whether any additional print data is input to the printing device 10 to be printed. If there is no additional print data input to the printing device 10 to be printed, the process ends.

However, if additional print data is input to the printing device 10 to be printed, the process goes to operation 118. At operation 118, header information of the additional print data is analyzed and an interpreter corresponding to the additional print data is determined. The header information of the additional print data is analyzed and an interpreter corresponding to the additional print data is determined to be the interpreter necessary to print the additional print data according to the header information of the additional print data.

Next, at operation 120, it is determined whether the interpreter previously stored in the predetermined memory of the printing device 10 is the same as the interpreter corresponding to the additional print data determined at operation 118. The interpreter previously stored in the predetermined memory can be either the interpreter corresponding to the previously printed print data or the preset default interpreter.

If it is determined at operation 120 that the previously stored interpreter is not the same as the interpreter corresponding to the additional print data, the process goes to operation 122. At operation 122, the previously stored interpreter is removed from the predetermined memory of the printing device 10, and the process returns to operation 104. If the previously stored interpreter is not the same as the interpreter corresponding to the additional print data, the previously stored interpreter is determined not to be required to print the additional print data, and thus, is removed. At this time, at operation 104, a request is made to the server 30 for the interpreter corresponding to the additional print data.

However, if it is determined at operation 120 that the previously stored interpreter is the same as the interpreter corresponding to the additional print data, the process goes to operation 124. At operation 124, the additional print data is printed using the previously stored interpreter and then the process returns to operation 116. If the previously stored interpreter is the same as the interpreter corresponding to the additional print data, another interpreter does not need to be transmitted from the server 30 to print the additional print data, since the printing device 10 can use the interpreter previously stored in the predetermined memory of the printing device 10 to print the additional print data. Accordingly, if the previously stored interpreter is the same as the interpreter corresponding to the additional print data, the additional print data is analyzed and printed using the previously stored interpreter. Next, at operation 116, it is determined whether more additional data is input to the printing device 10 to be printed.

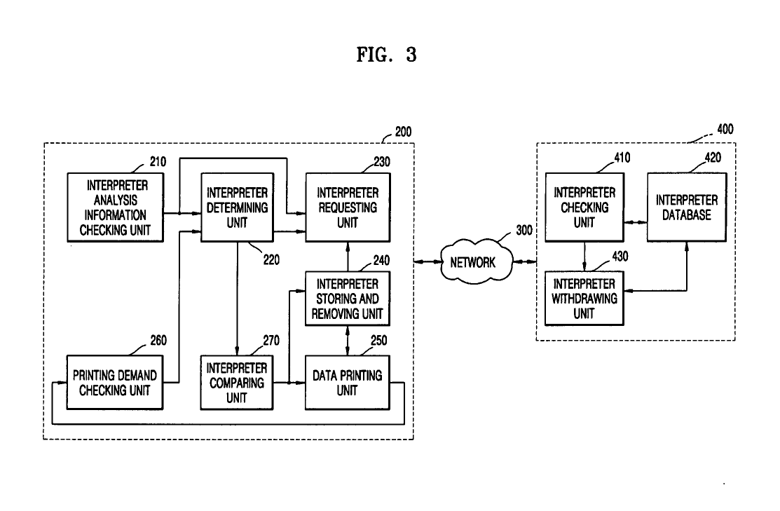

FIG. 3 is a block diagram of a system to print data over a network according to an embodiment of the present general inventive concept. Referring to FIG. 3, the system includes a printing device 200, and a server 400 to which the printing device 200 is connected via a network 300.

The printing device 200 includes an interpreter analysis information checking unit 210, an interpreter determining unit 220, an interpreter requesting unit 230, an interpreter storing and removing unit 240, a data printing unit 250, a printing demand checking unit 260, and an interpreter comparing unit 270.

The interpreter analysis information checking unit 210 determines whether interpreter analysis information is contained in header information of print data input to the printing device 200. When the print data is input to the printing device 200, the header information of the print data is also input to the printing device 200 together with the print data. The interpreter analysis information checking unit 210 determines whether the interpreter analysis information indicating which interpreter corresponds to the print data is contained in the header information, and outputs the determination to the interpreter determining unit 220 and the interpreter requesting unit 230.

The interpreter determining unit 220 analyzes the interpreter analysis information contained in the header information of the print data and determines an interpreter corresponding to the print data. When the interpreter determining unit 220 receives the determination from the interpreter analysis information checking unit 210 indicating that the interpreter analysis information is contained in the header information of the print data, the interpreter determining unit 220 analyzes the interpreter analysis information of the header information, determines the interpreter corresponding to the input print data, and outputs the determination to the interpreter requesting unit 230.

The interpreter requesting unit 230 requests the interpreter determined by the interpreter determining unit 220 from the server 400. When the interpreter requesting unit 230 receives the determination from the interpreter determining unit 220, the interpreter requesting unit 230 requests the determined interpreter from the server 400 via the network 300.

In the meantime, if the interpreter requesting unit 230 receives the determination from the interpreter analysis information checking unit 210 indicating that the interpreter analysis information is not contained in the header information of the print data, the interpreter requesting unit 230 requests a preset default interpreter from the server 400.

The interpreter storing and removing unit 240 stores the interpreter transmitted from the server 400. The determined interpreter or the default interpreter is transmitted to the printing device 240 via the network 300 from the server 400 upon the request of the interpreter requesting unit 230, and then is stored in the interpreter storing and removing unit 240. The interpreter storing and removing unit 240 can include a random access memory (RAM) to store data. In the case of using a RAM, if the printing device 200 is turned off, the interpreter stored in the interpreter storing and removing unit 240 is removed. The interpreter storing and removing unit 240 is not limited to the RAM, and can include various other storage units capable of storing data.

The data printing unit 250 prints the print data using the interpreter stored in the interpreter storing and removing unit 240. The data printing unit 250 loads the stored interpreter from the interpreter storing and removing unit 240, and prints the print data using the loaded interpreter. The data printing unit 250 outputs a print result to the printing demand checking unit 260.

The printing demand checking unit 260 responds to the print result of the data printing unit 250, determines whether additional print data is input to the printing device 200 to be printed, and outputs the determination result to the interpreter determining unit 220. If it is determined by the printing demand checking unit 260 that no additional print data is input to the printing device 200 to be printed, the operation of the system ends.

If it is determined by the printing demand checking unit 260 that additional print data is input to the printing device 200 to be printed, the determination result is output to the interpreter determining unit 220. The interpreter determining unit 220 responds to the determination result of the printing demand checking unit 260, analyzes header information of the additional print data, determines an interpreter necessary to print the additional print data, and outputs the determination result to the interpreter comparing unit 270.

The interpreter comparing unit 270 responds to the determination result of the interpreter determining unit 220, compares the previously stored interpreter with the interpreter corresponding to the additional print data to determine whether the previously stored interpreter is the same as the interpreter corresponding to the additional print data, and outputs the determination result to the interpreter storing and removing unit 240 and the data printing unit 250.

When the data printing unit 250 receives the determination result from the interpreter comparing unit 270 indicating that the previously stored interpreter is the same as the interpreter corresponding to the additional print data, the data printing unit 250 prints the additional print data using the previously stored interpreter, and outputs the print result to the printing demand checking unit 260.

When the interpreter storing and removing unit 240 receives the determination result from the interpreter comparing unit 270 indicating that the previously stored interpreter is not the same as the interpreter corresponding to the additional print data, the interpreter storing and removing unit 240 removes the previously stored interpreter and outputs the removal result to the interpreter requesting unit 230. Since the previously stored interpreter is not required to print the additional print data, the previously stored interpreter can be removed.

When the interpreter requesting unit 230 receives the removal result from the interpreter storing and removing unit 240, the interpreter requesting unit 230 requests the interpreter corresponding to the additional print data and determined by the interpreter determining unit 220 from the server 400.

The network 300 is a path through which data is transmitted between the printing device 200 and the server 400.

The server 400 can include an interpreter checking unit 410, an interpreter database 420, and an interpreter withdrawing unit 430.

The interpreter checking unit 410 checks whether the interpreter corresponding to print data requested by the interpreter requesting unit 230 of the printing device 200 is stored in the interpreter database 420. When the interpreter requesting unit 230 requests the interpreter corresponding to print data or an interpreter corresponding to additional print data, the interpreter checking unit 410 searches the interpreter database 420 in which a plurality of interpreters are stored to determine whether the requested interpreter is stored in the interpreter database 420, and outputs the determination to the interpreter withdrawing unit 430.

The interpreter database 420 can have the plurality of interpreters stored therein in advance. Often used interpreters can be included among the plurality of interpreters.

The interpreter withdrawing unit 430 selects the requested interpreter or the default interpreter from the interpreter database 420, and transmits the selected interpreter to the printing device 200.

When the interpreter withdrawing unit 430 receives the determination from the interpreter checking unit 410 indicating that the requested interpreter is stored in the interpreter database 420, the interpreter withdrawing unit 430 selects the requested interpreter from the interpreter database 420 and transmits the selected interpreter to the printing device 200 via the network 300.

In the meantime, when the interpreter withdrawing unit 430 receives the determination from the interpreter checking unit 410 indicating that the requested interpreter is not stored in the interpreter database 420, or when the interpreter requesting unit 230 requests the default interpreter, the interpreter withdrawing unit 430 selects the default interpreter from the interpreter database 420 and transmits the default interpreter to the printing device 200 via the network 300.

The interpreter transmitted to the printing device 200 is stored in the interpreter storing and removing unit 240 of the printing device 200.

As described above, the method and system to print data over the network according to the present general inventive concept selects an interpreter corresponding to data to be printed from a server in real time and prints the data. Accordingly, data can be printed without storing various kinds of interpreters in a printing device. As a result, a memory space required to store the various interpreters in the printing device is reduced.

Moreover, when a new interpreter is added or updated, only the server in which the plurality of interpreters are stored is updated with the new interpreter without updating respective printing devices, thereby facilitating data management of the interpreters.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of printing print data, comprising:
determining an interpreter corresponding to input print data;
downloading the determined interpreter from a server via a network;
storing the downloaded interpreter in a memory; and
printing the print data using the stored interpreter.

2. The method of claim 1, wherein the determining an interpreter comprises:
analyzing header information of the print data and determining the interpreter according to the header information.

3. The method of claim 2, wherein the analyzing of the header information comprises:
determining whether interpreter analysis information is contained in the header information;
selecting the interpreter according to the interpreter analysis information when the interpreter analysis information is contained in the header information; and
selecting a predetermined default interpreter when the interpreter analysis information is not contained in the header information.

4. The method of claim 1, wherein the downloading of the determined interpreter comprises:
requesting the determined interpreter from the server via the network;
determining whether the requested interpreter is stored on the server; and
downloading the requested interpreter when the requested interpreter is stored on the server, otherwise downloading a predetermined default interpreter from the server.

5. The method of claim 1, wherein the memory comprises a random access memory to temporarily store the downloaded interpreter.

6. The method of claim 1, further comprising:
determining an interpreter corresponding to additional input print data;
determining whether the determined interpreter corresponding to the additional input print data is the same as the stored interpreter;
printing the additional input print data using the stored interpreter when the determined interpreter corresponding to the additional input print data is the same as the stored interpreter, otherwise deleting the stored interpreter from the memory and downloading the determined interpreter corresponding to the additional input print data from the server; and
returning to the operation of determining an interpreter corresponding to additional print data.

7. A method of printing print data input to a printing device, comprising:
determining an interpreter corresponding to the input print data if interpreter analysis information is contained in header information of the input print data;
requesting from a remote server via a network the interpreter corresponding to the input print data if the interpreter analysis information is contained in the header information of the print data, otherwise requesting a default interpreter from the server;
transmitting and storing the requested interpreter from the server to the printing device; and
printing the print data using the stored interpreter.

8. The method of claim 7, further comprising:
determining whether additional print data input to the printing device is instructed to be printed;
determining an interpreter corresponding to the additional input print data if the additional input print data is instructed to be printed;
comparing the stored interpreter with the determined interpreter corresponding to the additional input print data; and
removing the stored interpreter from the printing device and returning to the operation of requesting from the server the interpreter corresponding to input print data if the stored interpreter is not the same as the determined interpreter corresponding to the additional input print data, otherwise printing the additional input print data using the stored interpreter and returning to the operation of determining whether additional print data input to the printing device is instructed to be printed.

9. A system to print data, comprising:
a server to store a plurality of interpreters therein;
a printing device comprising:
an interpreter determining unit to determine an interpreter corresponding to input print data,
an interpreter requesting unit to download the determined interpreter from the server,
a storage to store the downloaded interpreter, and
a printing unit to print the print data using the interpreter stored in the storage; and
a network to provide a communication link between the printing device and the server.

10. The system of claim 9, wherein the server comprises:
an interpreter database to store the plurality of interpreters;
an interpreter checking unit to search the interpreter database to determine whether the determined interpreter is stored in the interpreter database; and
a interpreter withdrawing unit to transmit the determined interpreter from the interpreter database to the printing device when the determined interpreter is determined to be stored in the interpreter database.

11. The system of claim 10, wherein when the determined interpreter is determined not to be stored in the database by the interpreter search unit, the transmission unit transmits a predetermined default interpreter stored in the interpreter database to the printing device.

12. The system of claim 9, wherein the interpreter determining unit analyzes header information of the print data and determines the interpreter according to the header information.

13. The system of claim 12, wherein the interpreter determining unit determines whether interpreter analysis information is contained in the header information of the print data and determines the interpreter according to the interpreter analysis information when the interpreter analysis information is contained in the header information.

14. The system of claim 13, wherein when the interpreter analysis information is not contained in the header information, the interpreter requesting unit downloads a predetermined default interpreter.

15. The system of claim 9, wherein the interpreter downloading unit requests the determined interpreter from the server, and downloads the requested interpreter from the server when the requested interpreter is one of the plurality of interpreters stored in the server.

16. The system of claim 15, wherein when the requested interpreter is not one of the plurality of interpreters stored on the server, the interpreter downloading unit downloads a predetermined default interpreter from the server.

17. The system of claim 9, wherein the printing device further comprises:
an interpreter comparing unit to compare the interpreter stored in the storage with an interpreter determined by the interpreter determining unit corresponding to additional print data input to the printing device to be printed and to determine whether the stored interpreter and the determined interpreter corresponding to the additional print data are the same.

18. The system of claim 17, wherein when the stored interpreter and the determined interpreter corresponding to the additional print data are determined to be the same by the interpreter comparing unit, the printing unit prints the additional print data using the stored interpreter.

19. The system of claim 17, wherein when the stored interpreter and the determined interpreter corresponding to the additional print data are determined not to be the same by the interpreter comparing unit, the stored interpreter is removed from the storage, the interpreter downloading unit downloads the determined interpreter corresponding to the additional print data, the storage stores the downloaded interpreter corresponding to the additional print data, and the printing unit prints the additional print data using the stored interpreter corresponding to the additional print data.

20. A printing apparatus communicating via a network with a server having a plurality of interpreters stored therein, the printing apparatus comprising:
a interpreter determining unit to determine an interpreter corresponding to input print data;
a interpreter requesting unit to request the determined interpreter from the server and to download the requested interpreter from the server if the determined interpreter is stored in the server, otherwise to download a preset default interpreter stored in the server;
a storage to store the downloaded interpreter; and
a printing unit to print the print data according to the interpreter stored in the storage.

21. The printing apparatus of claim 20, wherein interpreter determining unit determines the interpreter according to header information of the print data.

22. The printing apparatus of claim 21, wherein when the header information includes interpreter analysis information, the interpreter determining unit determines the interpreter according to the interpreter analysis information, otherwise requests the server for a predetermined default interpreter.

23. The printing apparatus of claim 20, further comprising:
an interpreter comparing unit to compare the interpreter stored in the storage with an interpreter determined by the interpreter determining unit corresponding to additional input print data and to determine whether the stored interpreter and the determined interpreter corresponding to the additional input print data are the same.

24. The printing apparatus of claim 23, wherein when the stored interpreter and the determined interpreter corresponding to the additional input print data are the same, the printing unit prints the additional input print data according to the stored interpreter.

25. The printing apparatus of claim 23, wherein when the stored interpreter and the determined interpreter corresponding to the additional input print data are not the same, the storage removes the stored interpreter therefrom, the interpreter requesting unit requests the determined interpreter corresponding to the additional input print data from the server and downloads the determined interpreter corresponding to the additional input print data, the storage stores the downloaded interpreter corresponding to the additional input print data, and the printing unit prints the additional input print data according to the stored interpreter corresponding to the additional input print data.
